(19) United States
(12) Patent Application Publication
(10) Pub. No.: US 2014/0024427 A1
(43) Pub. Date: Jan. 23, 2014

(54) METHOD AND SYSTEM FOR PLAYING HEAD TO HEAD POKER GAMES

(71) Applicants: JOSEPH W. COLE, Las Vegas, NV (US); Timothy W. Cole, North Las Vegas, NV (US)

(72) Inventors: JOSEPH W. COLE, Las Vegas, NV (US); Timothy W. Cole, North Las Vegas, NV (US)

(21) Appl. No.: 13/554,139

(22) Filed: Jul. 20, 2012

(51) Int. Cl. A63F 13/00

(52) U.S. Cl. 463/13

(57) ABSTRACT

In a gaming system and method, a head to head poker game is presented to first and second players of first and second gaming machines. Two hands of cards are displayed to the players. The first player to make a hand selection from the two hands is assigned that hand and the remaining hand is assigned to the other player. The two players then play out their hand and attempt to achieve the hand with the highest rank.

### FIELD OF THE INVENTION

The present invention relates to gaming machines and poker games.

### BACKGROUND OF THE INVENTION

Poker is a popular card game that was traditionally played with physical cards at a gaming table. Because of the popularity of poker, video poker gaming machines were developed. These gaming machines permitted players to play poker in an automated fashion at gaming machines. While video poker is very popular, it differs from traditional poker in that the player plays against a pay table of hands rather than against other players. Thus, various aspects of the traditional game of poker, such as bluffing, raising and calling and the like, are lost in the game of video poker.

Recent advances in computing technology have permitted traditional game of poker to be implemented in an on-line type environment. In such an implementation multiple players may login to a server, such as via a website. The players may be assigned to a virtual game table. A graphic of that table and each player's game actions is displayed to each player, such as at a video display of the player's computer.

While such an implementation retains the head-to-head play of traditional poker, it has several disadvantages. One problem is that the players generally cannot see one another and thus strategies like bluffing are hard to implement because each player cannot visually assess the face of each other player. Also, players in the on-line environment are often automatically assigned to gaming tables. While players may be automatically assigned to live tables, particularly in tournaments, such assignments may be based upon skill level. On the other hand, most on-line assignments are performed to prevent player collusion and thus the assignments may be random. This may result in a low skill player playing against a number of highly skilled players, thus making the game very difficult for the unskilled player.

New and exciting implementations for poker games are thus desired by players.

### SUMMARY OF THE INVENTION

Aspects of the invention comprise gaming machines, gaming systems, methods of game play and game features.

In one embodiment, a gaming machine includes multiple electronic displays for displaying different information relating to a single game. Relative to a poker game, one display may display card information, another display may display handicap or help information, and yet another display may display game score, winning results or other information.

In one embodiment, a gaming system includes at least two gaming machines. The gaming machines are linked, either directly or by or more additional devices such a game servers. In this manner, at least two players may participate in a single game. In one embodiment, the gaming machines are linked to permit the players to play one another in a head-to-head format.

One embodiment of a game comprises a head-to-head poker game. As one aspect of such a game, first and second hands of cards may be displayed to first and second players. Each player attempts to be the first one to select one of the hands. The first player to select a hand is assigned that hand and the remaining hand is assigned to the other player. The two players then play out their hands, such as by holding/discarding/replacing cards in a draw poker format, and the winner of the game comprises the player with the highest ranking poker hand.

In accordance with another aspect of the invention, player game play is tracked and used to assign a player a score or handicap. The player's score or handicap may be used to choose or assign competing players in head-to-head or multi-player games, or be used to change game odds, payouts or the like. In one embodiment, a player may be permitted to view or research other player's scores or handicaps, such as for assessing the skill of their competition.

In accordance with one embodiment of a game, a player who wins the most games from a set of games may be awarded a bonus award (such as an award separate from any award associated with wins of the individual games). In a head-to-head environment, first and second players may play multiple head-to-head poker games. The winning player of each individual game may be awarded winnings, such as a portion of wagers placed by the players to play each game. In addition, however, the player who wins the majority of the games may be awarded a bonus award.

In accordance with another embodiment of a game, a player may be awarded a bonus award for achieving a particular score or status. In a head-to-head poker game environment a player may be awarded points for each individual game win. If the player achieves a predetermined point total, such as during an interval of time or based upon a certain number of games, the player may be awarded a bonus award. In one embodiment, that bonus award may comprise a progressive jackpot.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a gaming system in accordance with the invention;

FIG. 2 illustrates one embodiment of a gaming machine at which a game in accordance with the present invention may be presented;

FIG. 3 is a flowchart illustrating one embodiment of game play in accordance with an embodiment of the invention; and

FIGS. 4A-4E illustrate one example of game play in accordance with a game of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises gaming machines and gaming systems configured to present one or more games, and embodiments of poker games. One embodiment of the invention is a head-to-head poker game in which two players of different gaming machines play a poker game against one another.

Gaming Systems and Gaming Machines

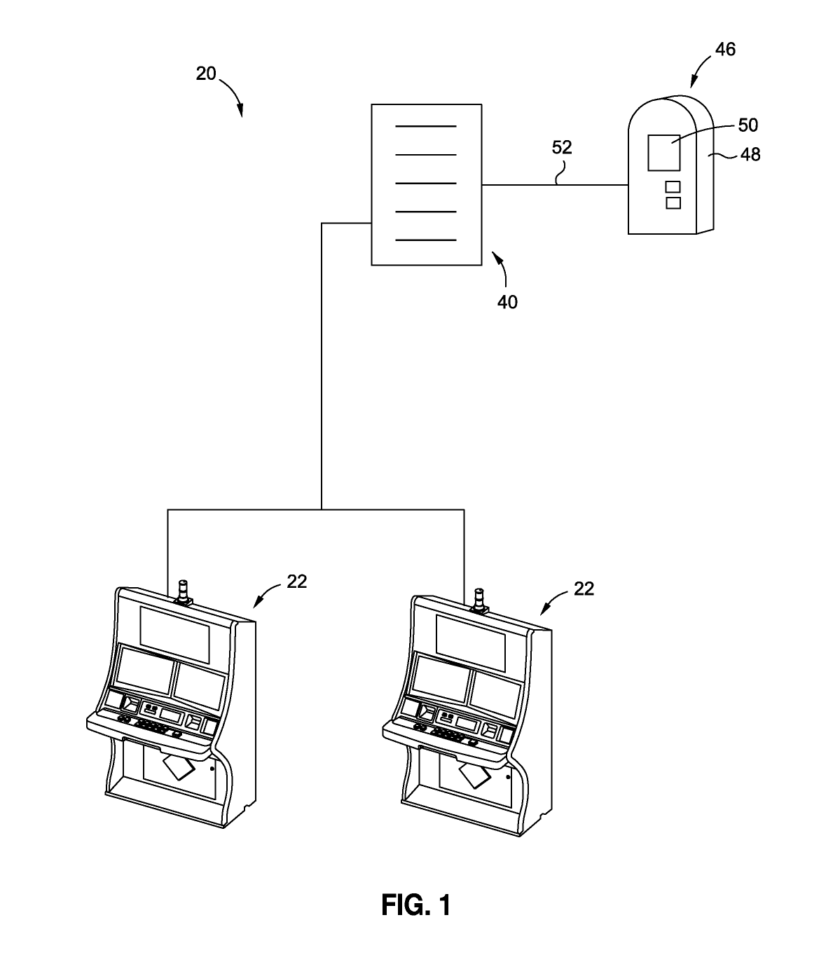

FIG. 1 illustrates one embodiment of a system 20 which may comprise an environment for implementing a game of the invention. As illustrated, the system 20 includes at least two gaming machines 22, at least one server 40 and at least one kiosk 46.

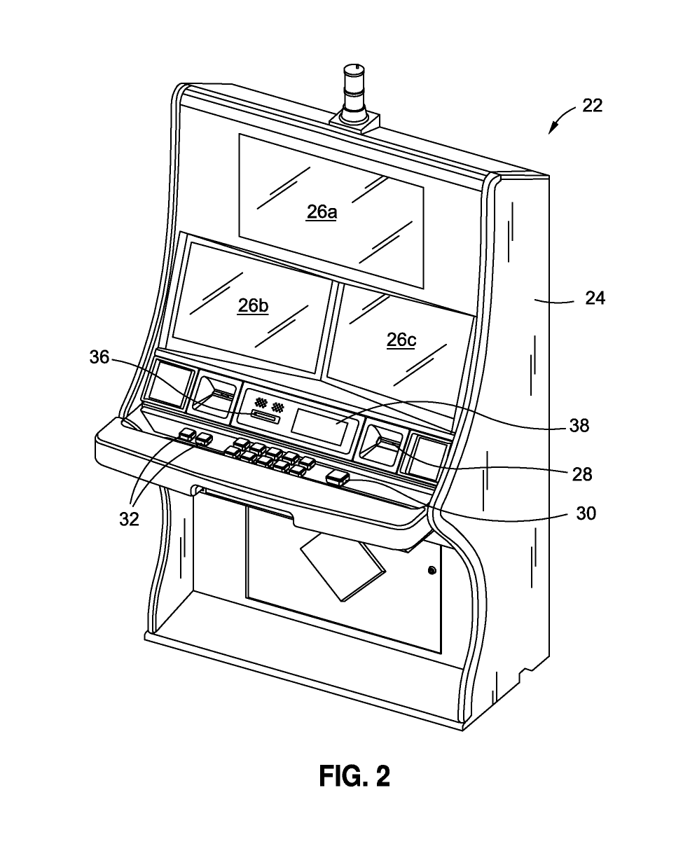

One embodiment of a gaming machine 22 of the invention is illustrated in FIG. 2. As illustrated, the gaming machine 22 may include a housing or cabinet 24 for enclosing/supporting various components of the gaming machine. The housing 24 may have a variety of configurations. In one embodiment, as illustrated, the housing 24 is configured so that the machine has a “slant” configuration. The gaming machine 22 might also be configured as an “upright”-type, “bar-top” or form of gaming machine.

In one embodiment, the gaming machine 22 may be configured as a “video” type gaming machine, the machine including at least one display for displaying game information to a player. The gaming machine 22 may include other means for providing information to a player. For example, speakers (not shown) or other devices may be provided for generating sound associated with the game. The gaming machine 22 may also include lights, printed instructions and other displays/display devices.

As indicated below, as one aspect of the invention, games may be implemented which involve two or more players. Such games may have a head-to-head format. In order to permit the players who are involved in a game to communicate with one another, each gaming machine 22 may include a microphone, camera or other device for capturing sounds or images. Likewise, each gaming machine 22 may be configured to disseminate the audio from another machine or to show the captured images (still or moving images) from another machine. Such features may be integrated into the gaming machine 22 (such as by being peripheral devices of the main gaming machine controller) or be add-on devices. Such devices may permit players to talk and/or see one another, such as to aid in “bluffing” in games of poker or the like.

In another embodiment, players might be permitted to send messages to one another. Such messages might comprise recorded voice messages, recorded images of the player, pre-recorded audio or visual messages or text messages. For example, a player might be permitted to select a pre-recorded audio message and send it to another player. Such a pre-recorded message might be stored as an audio file in a memory associated with the gaming machine controller and might be selected by the player from a menu or the like. In other embodiments, the message might comprise a text message, which text might be displayed on a display of the other player's gaming machine.

The games presented by the gaming machine(s) may be wagering type games wherein a player must place a bet or wager in order to play the game for the opportunity to receive winnings. Preferably, if the player is a winner of the game, the player is provided an award, such as a monetary payout (such as coins), credits representing monetary value, points or tangible prizes. The gaming machine 22 may thus include a bill validator/acceptor 28 for accepting paper currency and/or a coin acceptor (not shown) for accepting coins. Other means of payment, such as a credit card reader, may be provided.

Preferably, the gaming machine 22 includes means for a player to provide input. In one embodiment, this means comprises one or more buttons. For example, a “spin” or “deal” button 30 may be provided for permitting a player to start a game. One or more wager buttons 32 may be provided for a player to select the amount to bet on a particular game. Other means of input may be provided, such as a touch-screen display and other devices now known or later developed.

A game controller (not shown) is provided for controlling the various devices of the gaming machine and for generating game information. For example, the game controller may be arranged to generate video and audio data for presentation by the display(s) and speakers of the gaming machine 22. The game controller may be arranged to detect a signal from the coin acceptor indicating the receipt of coins or from the bill validator regarding accepted bills and for registering credits corresponding to those inputs, for subtracting credits for wagers placed by a player and for paying winnings and/or returning to a player of unwagered credits. Preferably, the one or more player input devices provide an output to the gaming controller for use in play of the game. For example, in response to a “bet one” input by a player, the gaming controller is preferably transmitted a signal which causes the gaming controller to initiate presentation of the game.

The gaming machine 22 may include one or more random number generators for generating random game events and results. In other embodiments, game results or information may be generated remotely (such as by a remote game server) and be transmitted to the gaming machine 22.

As indicated, in one embodiment, game information is displayed by a video display to a player. That display may be of a variety of types, including CRT, LCD, plasma and others. In a preferred embodiment, the gaming machine 22 has at least one video display, more preferably two video displays, and most preferably three video displays 26a, 26b, 26c.

In another embodiment, the gaming machine 22 could include other or additional display devices, such as one or more physical reels capable of displaying symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference. For example, the base symbols might be associated with spinning reels. Sets of base symbols might be generated by spinning those reels.

Such gaming machines 22 may have other configurations, including other features. For example, the gaming machine 22 may include a player tracking device, such as a card reader 36 and associated keypad 38. Such player tracking devices are well known and may permit the game operator to track play of players of the gaming machine. The tracked play may be utilized to offer player bonuses or awards.

In one embodiment, the gaming machine 22 may be configured to dispense media, such as printed paper tickets, which have associated value. For example, winnings or unused credits may be returned to the player via a printed ticket having value or associated value. In one embodiment, the gaming machine 22 might also be configured to accept such media for providing credit for game play. Relative to such gaming machines 22, an accounting server (not shown) may be used to generate ticket information to permit the gaming machine to dispense a value cash-out ticket, or to verify such a ticket which is presented at one of the gaming machines 22. Such systems are well known and thus not described in detail herein.

A casino may have numerous such gaming machines 22, such as located on a casino floor or in other locations. Of course, such gaming machines 22 might be used in other environments, such as an airport, a bar or tavern or other locations.

As indicated herein, the gaming machine 22 may be configured to present games of the invention. However, the gaming machine 22 might be configured to present a variety of games which are now known or later developed. Such games include, but are not limited to, slot-type games, video slot and video poker games, keno games, bingo games, roulette games, craps games, lottery games, and various other card and dice games, among others.

As used herein, the term “gaming machine” is not limited to a gaming machine having the configuration just described, but may include other devices now know or later developed.

Referring back to FIG. 1, as indicated above, the system 20 also includes one or more system servers 40. Such system servers 40 preferably comprise computing devices which comprise at least one processor for receiving information, processing information or executing code or software, and generating an output, such as control instructions.

In one embodiment, each system server 40 includes means for storing information or instructions. Such means may comprise one or more memory devices. Such might comprise RAM, ROM (including EPROM, EEPROM, PROM) or other devices now known or later developed. In one embodiment, the game server 44 might comprise or be in communication with one or more mass data storage devices, such as one or more hard drives or the like.

The system server 40 preferably also includes at least one communication interface, by which it may receive and transmit information. The communication interface(s) may permit communications in accordance with various protocols (TCP/IP, 802.11xx, etc.) and in various forms and over various types of links (wired and/or wireless).

Each system server 40 might actually comprise a system or network of a plurality of elements or devices. For example, the system server 40 might comprise a network or system which includes multiple servers and related devices such as data storage devices, user interface features and the like. Such might comprise, for example, a user station which includes a video display and one or input devices (such as a keyboard, mouse or the like). Such a user station may permit an operator to interface with and manage or control the system server 40, such as to change operator settings and the like. The system server 40 might also comprise a router and one or more separate computing devices. The functions of the various computing devices might be segregated.

Although additional details of the system server 40 are described below, in general, the system server 40 may be configured to track game play at the gaming machines 22, implement games at the gaming machines 22 (including by generating game data or results), link two or more gaming machines 22 for play, track wagers, generate and redeem tickets, or perform various other functions.

As indicated above, the system 20 preferably also comprises at least one kiosk 46. The kiosk 46 may have various configurations. In one embodiment, the kiosk 46 comprises a housing 48, one or more devices for receiving player input and/or displaying or otherwise providing information to a player, and at least one credit dispensing mechanism. The information input/output devices may include, for example, an electronic touch-screen video display 50. Other input/output devices may include one or more push-buttons, keypads, keyboards and/or other elements. The credit dispensing mechanism may comprise, but it not limited to one or more of: a currency dispenser, a coin dispenser, a ticket or other media dispenser (such as a magnetic card dispenser), or a media writer (such an RFID encoder or the like).

In one embodiment, the kiosk 46 includes at least one processor for executing machine readable code or software, and at least one memory device for storing machine readable code or software for execution by the processor. In one embodiment, the kiosk 46 includes at least one communication interface, such as for establishing a communication link 52 with one or more other devices, such as the system server 40 and/or the gaming devices, such as the gaming machines 22.

Of course, the system may include other components or features. For example, various functions of the system might be performed by different servers or sub-systems which are linked to one another. The system might include various communication links to permit communications between devices, which links may be part of a LAN or WAN, include the Internet, and be wired or wireless communication links or combinations thereof. The system may include external presentation or access devices, such as a player's home or work computer or mobile devices such as specialized mobile gaming devices, tablets, PDAs or phones.

Games

Embodiments of the invention comprise poker games. Although the games of the invention may be implemented in various environments, the games of the invention are preferably implemented at or via a system 20 such as that illustrated in FIG. 1. As such, aspects of the games are described with reference to the system 20 illustrated in FIG. 1 and the gaming machine 22 illustrated in FIG. 2.

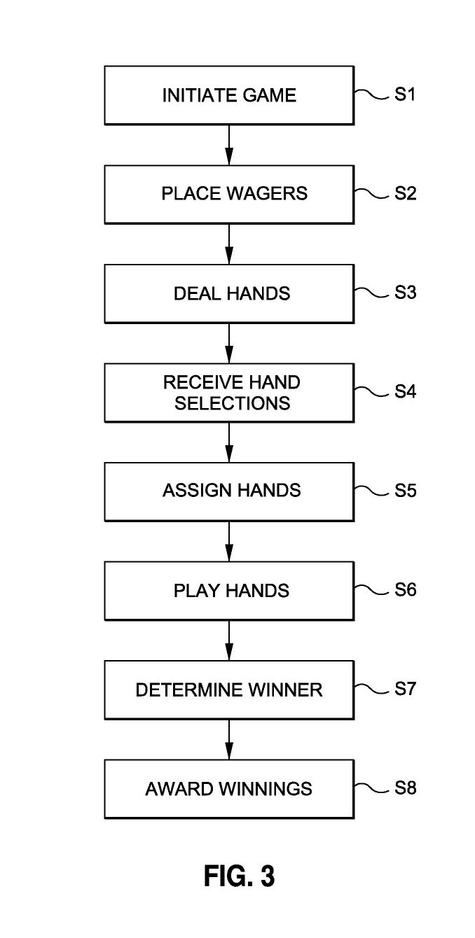

In one embodiment of a game, a first player and a second player may play a head-to-head poker game against one another. One embodiment of such a game will be described first with reference to FIG. 3. In a first step S1, a player preferably initiates the head-to-head poker game, such as at a gaming machine 22 such as that illustrated in FIG. 2.

In one embodiment, a player may identify themselves or take other action to indicate that they are “available” for play. This might comprise, for example, the player inserting a player tracking card into the card reader 36 of the gaming machine 22. The gaming machine 22 may then send a signal to the system server 40 or to other gaming machines 22 to indicate that a player is available for play at that gaming machine 22. In another embodiment, a player might provide input to the gaming machine 22, such as by touching a displayed “play game” button or the like to indicate that they wish to play a head-to-head poker game (for example, the gaming machine 22 may be configured to present a number of different games and the player may utilize a menu of games to make a game selection, one selection being the head-to-head game of the invention).

In one embodiment, the player may be randomly assigned to another player. In one embodiment, the player may select another player to play against. In another embodiment, the player might be assigned to play another player (such as assigned randomly by the server 40 or by certain criteria, such as the player's skill level or the like, as described below).

Once two players have been assigned to the game, each player preferably places a wager, as in a step S2. The wager may be of various sizes or amounts, such as comprising a minimum wager up to a maximum wager. In one embodiment, each player may be required to place a wager of the same amount. The wager might comprise monetary value credits, points, monies or the like (such as provided to the gaming machine 22 from an account, in the form of coins or currency or a media representing monetary value, such as a value ticket).

In a step S3, first and second hands of cards are dealt to the players. Preferably, the first and second hands of cards are shown to both the first and second players in a face up configuration (by which each player can see both hands of cards). However, the hands could be dealt in other configurations, as detailed below.

In a step S4, an input of a hand is received from one or both of the players. The input may comprise, for example, a player touching a touch-screen of a display which is displaying the hands of cards, in the vicinity of one or more of the hands. In other embodiments, a player might provide an input via a button, joystick or the like.

In a step S5, the first player who selects one of the two hands is assigned that hand of cards, and the remaining hand is then assigned to the other player.

In a step S6, each player plays out their assigned poker hand. The poker hands might be played out in various fashions, such as in accordance with various known poker game rules. In one embodiment, each player plays out their poker hand as a draw poker hand in which the player has the option of discarding none, one or more or all of their cards and is then dealt a replacement card for each discarded card.

In a step S7, the winner of the game is declared. In one embodiment, the winner is the player having the highest ranking poker hand, such as in accordance with the traditional rules or poker.

In a step S8, winnings may be awarded. In embodiment, such a step comprises awarding the amounts wagered by both players to the winning player. As disclosed below, the winnings may comprise the amounts wagered by the players less a house commission or vigorish. In other embodiments, the winnings might comprise a set amount, such as based upon a pay table of outcomes and awards.

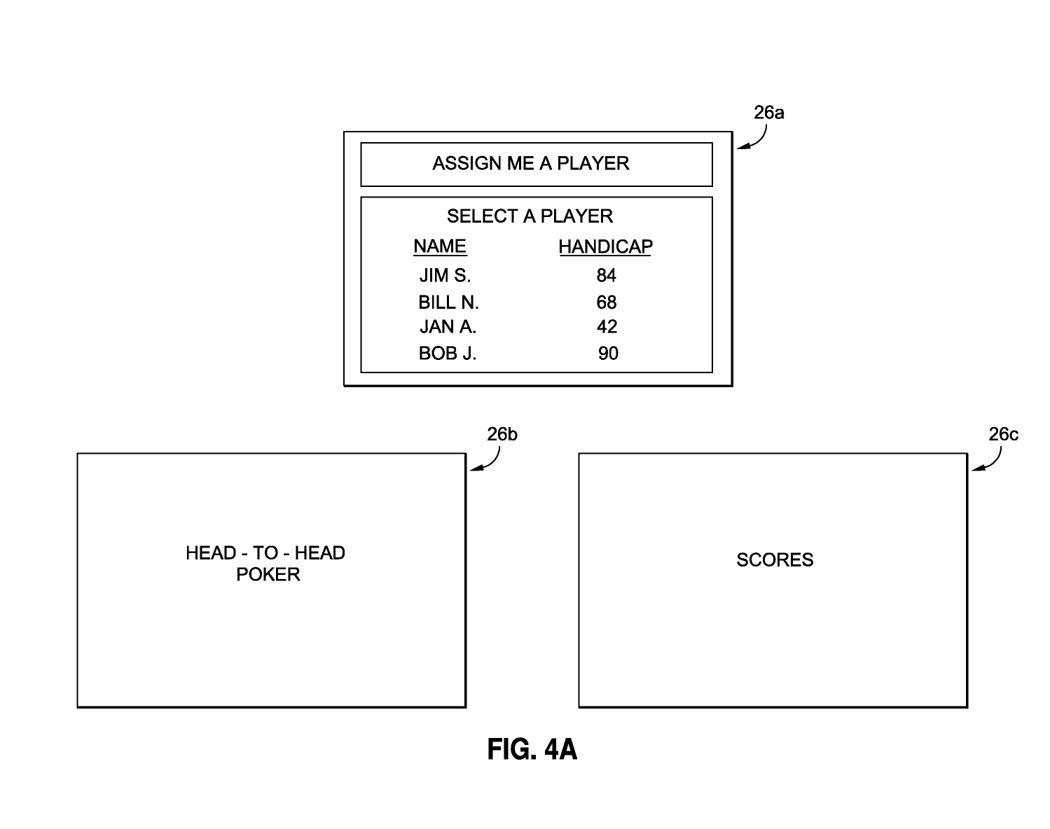

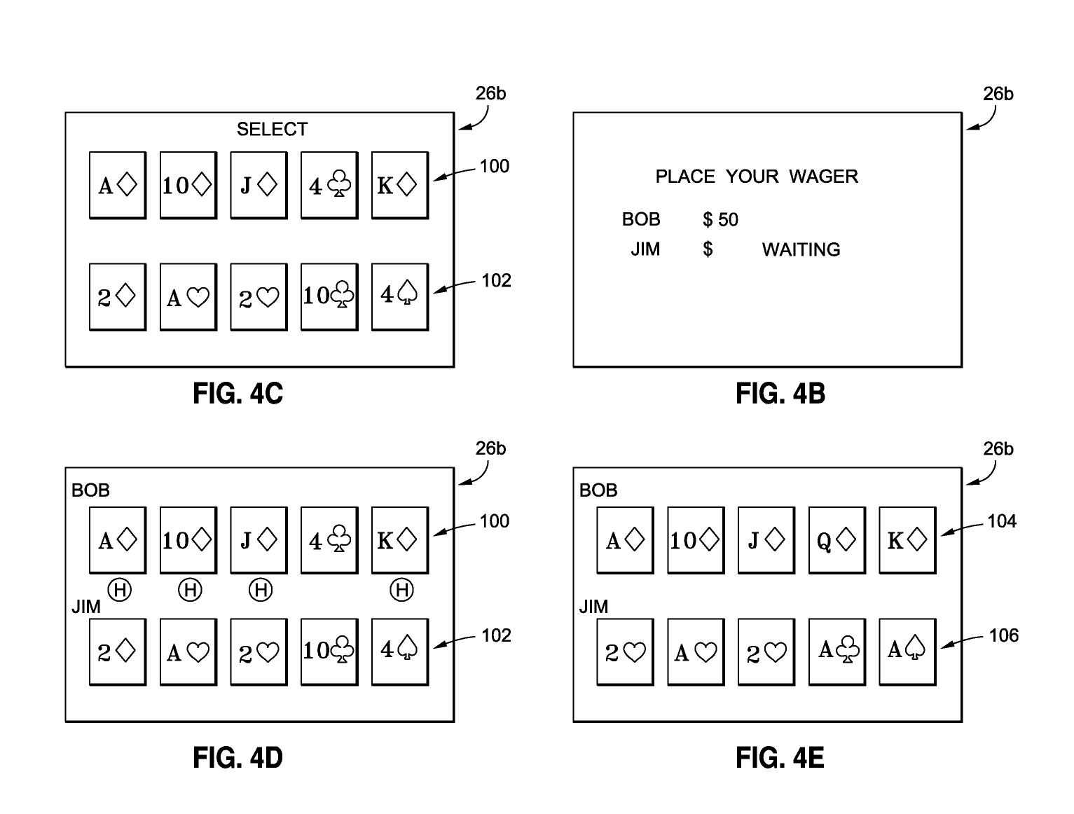

In example implementation of such a game will now be described with reference to FIGS. 4A-4E. In one embodiment, the game may be presented at gaming machines 22 such as that illustrated in FIG. 2, wherein the gaming machines 22 have three displays 26a, 26b, 26c.

In one embodiment, the first display 26a of each gaming machine 22 might display a list of available players. Thus, a player who sits down at a gaming machine 22 to play the game might be permitted to select an opponent. In one embodiment, as described in more detail below, the player information might include the name or alias of each available opponent (or another designator) and information regarding the player, such as player skill information. In another embodiment, the system might automatically assign an opponent to the player. Such a selection might be random or it might be based upon one or more criteria or factors such as the player's skill level, location or the like (and the opponent's skill level, location or the like). Also, the player might elect to have the system assign them an opponent, such as using such criteria.

Once an opponent has been assigned to the player, game information may be displayed to both players of the game, such as on a main game display 26b. For example, each player might be displayed a request to input a wager. As illustrated, a player Bob has placed a required wager of $50 and the system is waiting on the opponent, Jim, to place his wager. Upon inputting the required wager, information might be displayed to the players to ready themselves to select a poker hand.

As illustrated in FIG. 4C, first and second hands 100, 102 of cards may then be displayed to both players. The hands of cards 100, 102 may be displayed in various fashions. For example, as illustrated, all of the cards of both hands 100, 102 may be displayed face-up so that the values of all of the cards can be evaluated. In other embodiments, none or one or more but not all of the cards may be displayed face-up (the remaining cards may be displayed face-down). In one embodiment, the initial hands of cards comprise five (5) cards, though it is possible for the initial sets of cards to be displayed as less than five (5) cards (such as initial sets of one (1) or more cards which are completed into hands of a greater number of cards. The cards may be dealt from one or more decks of cards.

As indicated above, in a preferred embodiment each player attempts to select a desired hand. Preferably, the player who selects a hand first is assigned that hand and then remaining hand is assigned to the other player. In the embodiment illustrated in FIG. 4D, the player of the illustrated machine, Bob, has won the selection and has selected the first hand 100. The second hand is then assigned to the other player, Jim.

In one embodiment, the head-to-head poker game is played as a draw poker game in which each player has the opportunity to discard and replace one or more cards in their hand. As illustrated, Bob has elected to replace one card, the 4 [symbol] . Although information may or may not be displayed to Bob regarding Jim's elections, Jim has elected to discard and replace three cards.

After any discard and replacement, each player's final hand 104,106 may be displayed. As illustrated in FIG. 4E, Bob has achieved a Royal Flush, while Jim has achieved a Full House. Preferably, the outcome of the game is determined by using the standard poker hand rankings. As a result, Bob's Royal Flush outranks Jim's Full House.

Preferably, the winner of the hand is awarded winnings. In one embodiment, such comprises all of the amounts wagered ($100 in this example). In a preferred embodiment, a commission or vigorish is removed from the amounts wagered. This amount might comprise, for example, 5% of the total wagers. In such a configuration, Bob would be awarded $100*95%=$95 (with the $5 vigorish being taken by the house/casino).

It will be appreciated that the head-to-head poker game may have various formats. For example, as indicated above the poker game may comprise a 5 card draw poker game. While in one embodiment all 5 cards of the initial two hands are dealt face-up, in other embodiments less than all 5 cards might be dealt or displayed face-up. For example, 2, 3 or 4 cards of each hand might be dealt and displayed face-up, while the remaining card or cards may be dealt or displayed face-down.

It is possible for the game to comprise a stud poker game, such as a 5 card stud poker game. In such an embodiment, some but not all of the cards in each hand may initially be dealt face-up. In this manner, some “mystery” remains as to the ultimate outcome of the hands, but at the same time the one or more face-up cards may be used by the players in attempting to determine which hand may be the best one to try and select as their own hand.

In other embodiments the game might comprise a 7 card poker game. In such a configuration, two 7 card hands might be dealt and played to completion. In one embodiment, some but not all of the cards of each hand might be dealt face-up. After the players have attempted to select a desired hand and the hands have been assigned, the remaining cards of each hand may be displayed to their assigned player and the players may discard two of the cards from their hand to form a final 5 card hand.

In another embodiment, the poker game might utilize one or more community or common cards. For example, first and second hands of 3 cards may be displayed. The players may attempt to select one of those hands as their own. Once the hands have been assigned, two common cards might be dealt and displayed. The final hands of each player may comprise the initial 3 cards plus the 2 common cards.

Of course, a wide variety of poker games could be implemented in a head-to-head format. For example, in one embodiment games of Pai Gow or Omaha might be presented in such a format.

It will also be appreciated that the game may include various wagering options. As indicated, the game may require at least an initial wager. However, various additional wagers might be available throughout the game. For example, in the game described above, the players might make an initial wager, a wager after the hands have been assigned and a wager after cards have been discarded and dealt. Of course, a player might opt to cease play by not matching a wager, in which case the player might fold and allow the other player to win the game.

In yet another embodiment, as described below, the game(s) of the invention may include a jackpot feature. In such a configuration, a portion of each wager may be used to fund the jackpot. Such funding might comprise, for example, another 5% of the amounts wagered. In such a configuration as applied to the above-described example game, Bob would be awarded $90, $5 would go to the house as vigorish, and another $5 would be applied to one or more jackpots or award pools.

As one aspect of the invention, a player's game play may be tracked or monitored, such as for generating a player rating or handicap. In one embodiment of the invention a player might identify themselves at the gaming machine 22. The player might, for example, identify themselves using identification information such as a bio-metric identifier (fingerprint, retinal scan or the like), a player tracking card or other input of information (keypad PIN or the like). Once the player has been identified, the system 20 may be configured to monitor and track the player's game play.

In one embodiment, the system 20 may analyze the player's game play to determine a rating or handicap. For example, the player's rating or handicap might comprise a score relative to a perfect score, on a numerical scale. The rating might be determined in various fashions, such as by comparing the player's play against a theoretical “optimum” play strategy, by examining the player's win/loss ratio, by examining the player's monetary win vs. monetary loss, or other criteria or combinations thereof. For example, one factor in determining a player's rating may be the rating of the player's opponent. If a player with a high ranking plays a player with a low ranking, lower weight may be applied to wins achieved by the player with the high ranking as opposed to wins achieved by the player with the low ranking in their head-to-head games.

For example, based upon a player's play, the player might be assigned a ranking of 80 of 100. Another player might be assigned a ranking of 50 out of 100. The player's rating and/or other information, such as player statistics, might be stored in association with the server 40 or other component(s) of the system 20. For example, various data files or records may be used to store such information, such as in conjunction with the player's name or other identifier.

In one embodiment, player ratings information may be used in various fashions. As indicated above, playing ratings may be used when assigning or selecting an opponent in a head-to-head poker game. A player with an 80 rating might, for example, select a player with a similar rating to challenge themselves, or might select a player with a lower rating to obtain a perceived higher probability of winning.

In one or more embodiment, limits might be placed upon a player's ability to select players with certain ratings. For example, a player might not be permitted to select another player with a rating of more than 10 points less (or other variation), or might only be permitted to select a player with the same or a higher rating.

In one embodiment of the invention, if a player is permitted to select an opponent, the opponent may be permitted to decline to play. For example, a first player with a rating of 50 might be asked to play against a second player with a rating of 80. In one embodiment, when the second player requests to play the first player, the first player might receive a message such as “Bob S. with a rating of 80 wishes to play you. Do you Accept or Decline?”. The first player may then evaluate whether to accept the invitation.

In one embodiment, players might be permitted to research other players. For example, a player might be presented with a list of available players. The player might be permitted to see or obtain each player's rating and/or other information. For example, by selecting a particular opponent from a list, the player might be permitted to see or obtain other or more comprehensive information. Such information might include how long the player has been playing on the system, the number of games the opponent has played, the opponent's win percentage and/or other information.

As another aspect of the invention, a player might be permitted to look up or research player or game play statistics or otherwise obtain game help. For example, a player might be permitted to view hand odds tables, view game guides or instructions, research game play statistics for particular games or players, or research odds probabilities (such as the probabilities of a competing player having hand with a certain rank or a rank which is higher than the player's current hand). Such information might be displayed on the one or more displays of the gaming machine 22, such as in response to a player's selection of such information from a menu or the like.

As another aspect of the invention, various game play features could be adjusted based upon the player's score or handicap. For example, the odds or payouts for certain outcomes might be varied based upon the player's score or handicap.

Another aspect of the invention is games which include time and/or score features. A player might be awarded winnings, such as a jackpot, for achieving certain criteria in a period of time or by achieving a certain score or the like.

As one example, in one variation of a head-to-head poker game such as that described above, the players may attempt to win the most games or hands during a designated period of time. The player who wins the most hands may be awarded winnings. These winnings may be in addition to the winnings for each winning game or hand. Such additional winnings might be paid from the vigorish which the house retains from the wagers on each game.

As one example, players of the head-to-head poker games may play games during a time period. Such a time period may be set by the game operator/casino or be selected by the players or the like (such as by inputting a time period or selecting a time period from a menu of time periods). For example, the players might agree to a 1 hour game period.

During the game period the outcomes of the games may be tracked. In one embodiment, the winning player of the timed gamed event is the player who wins the most games or hands which the players play during the game period. Of course, other criteria might apply, such as which player wins the most winnings or the like.

In order to ensure that neither player holds up the game play process, the players may be required to play each game within a designated time or take certain actions within certain time periods, or risk forfeiting the game. For example, each player might be required to place their wagers in a certain period of time, hold/draw cards in a certain period of time or the like. If a player did not provide input regarding cards to be held/discarded within a required period of time, the other player might be automatically designated to be the winner of that game. Of course, the gaming system and/or gaming machines may be configured to display timers or other information to each player regarding actions which must be taken and designated times (including count-down clocks) for designated actions.

In one embodiment, as indicated above, the winner of the timed gaming event may be awarded an award. For example, in the case where the house retains a vigorish of 5% of the wagers placed by both players on each game, the house might set aside 3% for a timed gaming event jackpot. All or a portion of the jackpot may be awarded to the winning player.

In one embodiment, if a player ceases to play games during the timed gaming event, that player may forfeit and thus the other player may be automatically designated to be the winner. In another embodiment, the other player might only win if they have a greater number of winning hands (or winnings) when the player quits.

In yet another embodiment, the other player may be required to play against the house for a designated number of games or until the time period expires. As one example, a first player and a second player may have played 10 games, 3 of which were won by the first player and 7 of which were won by the second player. The second player quits with 15 minutes remaining during the timed gaming period. The first player may play games against the house (such as a game server), in an attempt to win an additional 5 games and thus end up with a winning game total of 8 hands vs. 7 hands for the second player.

As another aspect of the invention, players might play for a high score or similar criteria, such as for the opportunity to win an award. Such a feature may be applied to the head-to-head poker game herein, including such a game which is also played as part of a timed gaming event.

In one embodiment, players of the head-to-head poker games may be assigned scores. Players who meet certain criteria, such as high scores, may be awarded winnings.

Players might be assigned points or the like, such as based upon various criteria. For example, points might be assigned for each game which a player wins, the rank of a player's winning hand, the rank of the final hand of the player in each game (whether won or lost), the amount of player game winnings, or other criteria or combinations thereof.

The high score or similar feature might be implemented in various manners. First, scores might be evaluated over a certain number of games (e.g. highest score(s) achieved during X number of games) or during a time period (such as a 1 hour head-to-head time period, a day, a month or the like).

Second, the feature could be applied to just the two players of the head-to-head game, it could be applied to all players of a certain gaming machine, it could be applied to all players of a certain group, or it could be applied to all players on a gaming system or within a casino. It could also be applied to a player who plays against the house/casino.

As one example, the gaming system might be configured to select a target score, such as 10,000 points. Any player who achieved the target score during the play of a 1 hour head-to-head poker event might be awarded a jackpot. In such a scenario, the head-to-head poker system would monitor each player's play, assign scores and determine if the player reached the target. If a player reached the target score then that player would be awarded the designated award (again, such an award may be separate from any winnings for each poker or other game or awards for other events, such as timed gaming events).

As another example, the player who achieves the highest score associated with a certain number of games during a designated period of time might be declared the winner. For example, the player who achieved the highest score during a certain number of head-to-head poker games or during a head-to-head poker session, such as played on a certain day, might be declared the winner. As one example, on May 1, 2012, combinations of pairs of players may play 50 different head-to-head poker sessions (such sessions might be for a designated number of games or time periods). The player who had the highest score from amongst those 50 sessions may be declared the winner.

In one embodiment, the winner of the event may be awarded an award such as a designated monetary or credit award or a jackpot, progressive or other award or a portion thereof. In one embodiment, multiple winners might be declared, such as the players with the top 3 or 10 scores. In other embodiments, a player might be declared a winner for achieving one or more score levels. For example, a player might win a base award for achieving a score of a first level and might win a different or higher award for achieving a score of a second level.

Once again, the awards may be funded in various manners. In one embodiment, the awards may be funded from the house/casino vigorish from the wagers associated with each individual game.

In certain embodiments of the invention, various awards may be funded by separate or additional wagers. For example, each player who wishes to play for a high score award may be required to place an additional side wager in addition to the wager placed to play the other player in the head-to-head games.

In one embodiment of the invention, a player can play head-to-head poker against the gaming machine 22 or the system, rather than another player. In one such configuration, the player may be permitted to select the desired hand from the two displayed hands. The player then plays out that hand against the other hand, which is played by the house (such as by the gaming machine 22 or the server 40). The player may be awarded winnings for each win, such as based upon house wagers which match the player's wager(s) or based upon a pay table of payouts.

In one embodiment, the player may similarly play the games as part of a timed gaming event or for a score. For example, a player might play a number of games against the gaming machine 22 in an attempt to achieve a high score or to win the greatest number of games during a timed gaming period.

It will be appreciated that various aspects of the invention may be applied to other gaming machines, systems and games. For example, the player handicapping system may be applied to various poker games. Such games could include online poker games. Such games are known and generally involve multiple players playing standard table-type poker via a computing system. In such a configuration, the players of such a game may each be assigned a handicap or score and may see the handicap or score of other players. Such handicap information may be used by the player in determining whether they wish to “sit” (in the virtual sense) at the gaming table in play, and/or to determine what strategy the player may wish to employ when playing the game.

Aspects of the pick-a-hand feature might be applied to other games or environments. For example, in one embodiment of a game, a plurality of players (preferably three or more) might play multiple poker games. Each player may be presented with two card hands at the beginning of each game. Each player may be required to select one hand and then plays that hand to completion. Each player may be assigned a score based upon the outcome of the hand, such as in a traditional video-poker type arrangement where the final hand is evaluated against a pay table of hands (some of which are “winning” and some of which are “losing”, and where winning hands may have associated scores or payouts). The players might play a designated number of hands or for a designated time period which each player attempting to achieve the highest score. The player or players with the highest score might be awarded an award, such as a jackpot or a portion of a jackpot (each player might be required to place a wager to play the one or more games, such as all games during the time period, or might be required to place a wager to play each game during the event).

In one embodiment of a system of the invention, different game information may be displayed on different displays of a single gaming machine 22. In one embodiment, as illustrated in FIG. 4A, one or more displays might be used to display game information. One or more other displays might be used to display player handicap or similar information and/or game scores.

For example, relative to a game in which players pay for high scores or similar criteria, the criteria (such as the target score) and current standings may be displayed. For example, a player may be playing head-to-head poker for a score. Game information may be displayed on the main display 26b. The score of the player and the player's opponent may be displayed on a secondary display 26c. Of course, in the event other players are involved in the event, their scores may be displayed as well. The displayed information could include the player's name or nickname, each player's current score, the number of hands or time left in the event, etc.

As one aspect of the invention, a player may be rewarded for playing games against a higher ranked opponent. For example, the player might be rewarded with increases in their score or handicap when they win games against a higher ranked opponent. In other configurations, the player might be awarded additional or higher winnings. For example, in a head-to-head format the winning player might be paid an award based upon a pay table of winning hands or outcomes. The pay table may have base payouts for regular wins and have bonus or higher payouts for wins against a higher ranked opponent. As one example, a player who wins a head-to-head poker game by having a Full House hand might be awarded 25 credits under normal circumstances. If the player is playing against a higher ranked opponent, the award may be increased to 30 credits.

The player tracking information may include information other than just a score or handicap. For example, the information might include a wide range of statistics regarding game play, such as the number of hands played, the winning/losing percentages, the number of times particular hands were achieved (Three of a Kind, Full House, Four of a Kind, etc.), the number of hands the player took 0, 1, 2, 3, 4 or 5 replacement cards, etc.

In one embodiment, play statistical information (including handicap or score) and/or game score information might be available remotely. For example, a player might be permitted to login to a webpage which is supported by the server 40 of the gaming system 20. The player might access the webpage from a remote computing device such as a work computer, home computer or a mobile device such as a tablet, PDA or phone. The player might check current game scores (such as to determine if they are the current high score holder or what the current high score is) or to research other players, such as other players' handicaps or game statistics.

In one embodiment, the game might be provided with a card “peek” function. Such a function might permit a player to have their cards displayed in formats which make them hard to be read by third parties, such as an opponent who might be playing an adjacent gaming machine. For example, the player might select a display format which causes their cards to be displayed in a smaller format or size than normal. In other embodiment, the player's cards might be displayed only on a lower display (for example, relative to the configuration illustrated in FIG. 4A, the player's cards are preferably displayed on one of the lower displays 26b or 26c, rather than the top or upper display 26a. In yet another embodiment, instead of images of cards, card rank and suit indicia might only be displayed (such as just the indicia K [symbol] ). In another embodiment, the viewing format might only display the player's card information momentarily, such as upon the player “touching” the card (and after the player stops touching the card, only the card back might be displayed).

As one aspect of the invention, a player may be permitted to cash-out their winnings in various manners. In one embodiment, wagers are placed in the form of electronic credits, where each credit has a representative monetary value, such as $0.25. When a player wishes to cash-out, the gaming machine 22 might pay the player by dispensing currency and/or coins.

In yet another embodiment, the player might be dispensed a media, such as a printed ticket or a magnetic stripe card or the like. The media preferably stores information regarding the amount of the cash-out.

In one embodiment, the player might take the media to a cashier to be paid the value which is associated with the media. In another embodiment, the player might take the media to the kiosk 46. The kiosk 46 might read the media, such as by scanning a barcode on a ticket or reading a magnetic stripe or RFID tag associated with a card or FOB. The read information might provide the value information or might identify an account, ticket number or the like with which the value information is stored. The kiosk 46 may use that identification information to verify the media and the amount to be paid to the player and then pay the player. In one embodiment, the player might be paid by dispensing currency and/or coins, or might be paid by transferring funds to a player's bank account, debit card or the like.

It will be appreciated that game winnings may be tracked by the gaming machines 22 and/or the server 40. For example, in a head-to-head game, the gaming machines 22 may transmit game information to the server 40. The server 40 may thus track wagers made, game play and game outcomes, and associate game winnings with the players who are playing the game. If a player wishes to cash-out, the server 40 may generate cash-out ticket information which is transmitted to the gaming machine 22 and which information can later be verified (such as by a cashier or a kiosk when the ticket is to be redeemed).

In another embodiment, the gaming machines themselves might store value information, generate ticket or media information and then verify the tickets or media, in manner similar to that described in U.S. Patent Application Publication No. 2011/0183747 which is incorporated herein in its entirety by reference.

The game of the invention has various advantages and benefits. One aspect of the invention is a head-to-head poker game in which players attempt to select a hand from one of two or more hands. This feature of the invention creates much excitement as both players attempt to be the first player to make a selection in hopes of selecting the best hand and leaving the other player with the remaining hand. This feature of the invention is also challenging because each player not only wants to be the quickest at making a hand selection, but must be adept at reviewing and analyzing the hands in hopes of making the best hand selection.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of presenting a poker game to at least a first player of a first gaming machine and a second player of a second gaming machine comprising:
displaying a first poker hand of cards and a second poker hand of cards to said first and second players via at least one electronic display of said first gaming machine and at least one electronic display of said second gaming machine;
assigning said first and second poker hands of cards to said first and second players based upon input received from said first or second players, wherein if said first player makes a hand selection before said second player, assigning said selected hand to said first player and assigning the remaining of said first and second poker hands to said second player, and wherein if said second player makes a hand selection before said first player, assigning said selected hand to said second player and assigning the remaining of said first and second poker hands to said first player;
receiving input from said first and second players of none, one or more or all of said cards of said hand of cards assigned to said player to be discarded;
replacing each discarded card to form a final poker hand for said first player and a final poker hand for said second player; and
determining a winner of said game by comparing a ranking of said final poker hands of said first and second players.

2. The method in accordance with claim 1 further comprising the steps of receiving a wager from said first player at said first gaming machine and receiving a wager from said second player at said second gaming machine.

3. The method in accordance with claim 2 further comprising the step of awarding winnings to said winner of said game.

4. The method in accordance with claim 3 wherein said winnings comprise the sum of said wagers placed by said first and second players.

5. The method in accordance with claim 3 wherein said winnings comprise a portion of said wagers placed by said first and second players.

6. The method in accordance with claim 1 comprising presenting multiple of said poker games and awarding a bonus award to either said first or second player who wins a majority of said poker games.

7. The method in accordance with claim 6 further comprising receiving a wager from said first player to play said game and receiving a wager from said second player to play said game, funding a bonus pool using at least a portion of said wagers, awarding winnings to said winner of said game from said wagers and wherein said bonus award is paid from said bonus pool.

8. The method in accordance with claim 1 further comprising awarding points to said winner of said game.

9. The method in accordance with claim 1 wherein said step of displaying said first and second poker hands of cards comprises displaying 5 cards face-up comprising said first poker hand and another 5 cards face-up comprising said second poker hand.
